(19) United States
(12) Patent Application Publication
(10) Pub. No.: US 2013/0050727 A1
(43) Pub. Date: Feb. 28, 2013

(54) IMAGE PROCESSING APPARATUS AND POWER-SAVING METHOD OF IMAGE PROCESSING APPARATUS

(71) Applicant: Yoshinori MURATA, Kyoto-shi (JP)

(72) Inventor: Yoshinori MURATA, Kyoto-shi (JP)

(73) Assignee: MURATA MACHINERY, LTD., Kyoto-shi (JP)

(21) Appl. No.: 13/397,993

(22) Filed: Feb. 16, 2012

(30) Foreign Application Priority Data
Mar. 1, 2011 (JP) 2011-044048

(51) Int. Cl. G06F 1/32

(52) U.S. Cl. 358/1.13

(57) ABSTRACT

An apparatus includes a packet detecting unit; a packet analyzing unit; an image processing unit processing images using image data from the packet; a power supply unit supplying power to the packet detecting, packet analyzing, and image processing units; a stand-by mode controlling unit controlling the packet detecting unit, the packet analyzing unit, and the image processing unit to be operable in a stand-by mode; a first controlling unit controlling, in a first mode, the packet detecting and packet analyzing units to be operable while the image processing unit is inoperable; a second controlling unit controlling, in a second mode, the packet detecting unit to be operable while the packet analyzing and image processing units are inoperable; and a first mode-changeover unit changing a power supply mode from the second mode to the first mode when the packet detecting unit detects a predetermined packet in the second mode.

### CROSS-REFERENCE TO RELATED APPLICATIONS

This application claims priority under 35 U.S.C. 119 to Japanese Patent Application No. 2011-044048, filed on Mar. 1, 2011, which application is hereby incorporated by reference in its entirety.

### BACKGROUND OF THE INVENTION

1. Field of the Invention

The present invention relates to an image processing apparatus for sending/receiving a packet via a network.

2. Description of the Related Art

For example, a known structure is capable of preventing unnecessary power consumption by switching to a power-saving mode in which power consumption is relatively low after a prescribed period of time has passed since a command given by a user was executed. Such a structure may be adopted in an image processing apparatus, such as a copier or a multi-functional peripheral.

Such a multi-functional peripheral is provided with a main unit for controlling principle operations of the multi-functional peripheral, a local area network (LAN) communication unit for controlling network communication operation, and a facsimile (FAX) communication unit for controlling facsimile communication operation. Such multi-functional peripherals perform changeover between a first power-saving mode, in which power supply to the main unit is stopped, and a second power-saving mode, in which power supply to the main unit and the LAN communication unit is stopped.

When the above-mentioned multi-functional peripheral, in the second power-saving mode, receives image data through FAX communication or an instruction from a user to return the power supply mode to a stand-by mode, power is supplied to the main unit. In this second power-saving mode, the multi-functional peripheral is incapable of performing network communication since power supply to the LAN communication unit is completely stopped.

Meanwhile, a multi-functional peripheral which keeps supplying power to the LAN communication unit as in the stand-by mode has a disadvantage that the multi-functional peripheral wastes power as power is continuously supplied to the LAN communication unit even if the multi-functional peripheral is not performing network communication.

### SUMMARY OF THE INVENTION

In view of the above-described problems, preferred embodiments of the present invention provide an image processing apparatus capable of preventing unnecessary power consumption and performing excellent network communication.

According to a preferred embodiment of the present invention, an image processing apparatus that sends/receives a packet via network includes a packet detecting unit arranged to detect receipt of a packet, a packet analyzing unit arranged to analyze the packet detected with the packet detecting unit, an image processing unit arranged to process an image using image data extracted from the packet with the packet analyzing unit, a power supply unit arranged to supply power to the packet detecting unit, the packet analyzing unit and the image processing unit, a stand-by mode controlling unit arranged to maintain all of the packet detecting unit, the packet analyzing unit and the image processing unit to be capable of operating in a stand-by mode, a first power-saving mode controlling unit arranged to, in the first power-saving mode, maintain power supply status so that the packet detecting unit and the packet analyzing unit are capable of operating while the image processing unit is incapable of operating, a second power-saving controlling unit arranged to, in a second power-saving mode, maintain the power supply status so that the packet detecting unit is capable of operating while the packet analyzing unit and the image processing unit are incapable of operating, and a first mode-changeover unit arranged to change a power supply mode from the second power-saving mode to the first power-saving mode when the packet detecting unit detects a particular packet in the second power-saving mode.

With the apparatus according to a preferred embodiment of the present invention in the second power-saving mode in contrast to the first power-saving mode in which the packet analyzing unit is capable of operating, power supply is set so that the packet analyzing unit is incapable of operating, which further reduces power consumption. Even in the second power-saving mode, when the packet detecting unit detects a particular packet, the power supply mode of the image processing apparatus is switched to the first power-saving mode. This changeover enables the packet analyzing unit to analyze the received packet, which also enables the image processing apparatus to execute network communication. Thus, the image processing apparatus can prevent unnecessary power consumption and also perform efficient network communication.

The image processing apparatus in accordance with a preferred embodiment of the present invention also preferably includes a determining unit arranged to determine, based on an analysis conducted by the analyzing unit, whether image processing needs to be performed, and a second mode-changeover unit arranged to the switch power supply mode to the first power-saving mode.

If it is determined that image processing needs to be performed based on the analysis of the packet, the power supply mode is changed from the first power-saving mode to the stand-by mode, and immediately the image processing apparatus in accordance with a preferred embodiment of the present invention starts an image processing operation.

The image processing apparatus in accordance with a preferred embodiment of the present invention also preferably includes a monitoring unit arranged to monitor operations to determine whether a packet has not been sent/received for a first predetermined period of time in the first power-saving mode, and a third mode-changeover unit arranged to change the power supply mode from the first power-saving mode to the second power-saving mode based on the monitoring performed by the monitoring unit.

With the image processing apparatus in accordance with a preferred embodiment of the present invention, only when a packet has not been sent/received, is the power supply mode changed from the first power-saving mode to the second power-saving mode. In other words, network communication can be prevented from being disrupted due to mode changeover to the second power-saving mode during packet communication, which eventually enables the image processing apparatus to execute efficient network communication.

The image processing apparatus in accordance with a preferred embodiment of the present invention also preferably includes a second monitoring unit arranged to monitor operations of the image processing unit to determine whether the image processing unit has not operated for a second predetermined period of time in stand-by mode, and a fourth mode-changeover unit arranged to change the power supply mode from the stand-by mode to the first power-saving mode.

With the image processing apparatus in accordance with a preferred embodiment of the present invention, if the image processing unit has not operated for the second predetermined period of time, the power supply mode is changed from the stand-by mode to the first power-saving mode, which reduces power consumption.

The image processing apparatus in accordance with a preferred embodiment of the present invention also preferably includes a mode-changeover directing unit arranged to, in the stand-by mode, receive an instruction to the switch power supply mode to the first power-saving mode, and a fifth mode-changeover unit arranged to change the power supply mode from the stand-by mode to the first power-saving mode according to the instruction given to the mode-changeover directing unit.

With the image processing apparatus in accordance with a preferred embodiment of the present invention, the power supply mode is also changed from the stand-by mode to the first power-saving mode when an instruction to switch the power supply mode to first power-saving mode is supplied through the mode-changeover directing unit. Therefore, operating the mode-changeover direction unit based on user's intent allows the image processing apparatus to prevent unnecessary power consumption more effectively.

Meanwhile, it is preferred that the power supply mode is automatically changed from the first power-saving mode to the second power-saving mode without an operation by a user. The automatic changeover prevents a complicated operation and user's confusion and the like due to setting of a plurality of power-saving modes.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram illustrating an electric structure of a multi-functional peripheral in accordance with a preferred embodiment of the present invention.

FIG. 2 is a block diagram illustrating a specific structure with respect to network communication via a network board.

FIG. 3 is a flow chart explaining an example processing by a central processing unit (CPU) when the power supply mode of a multi-functional peripheral is sequentially shifted from the stand-by mode through the second power-saving mode.

FIG. 4 is a flow chart explaining an example processing by a CPU when the power supply mode of the multi-functional peripheral is sequentially returned from the second power-saving mode through the stand-by mode.

### DETAILED DESCRIPTION OF THE PREFERRED EMBODIMENTS

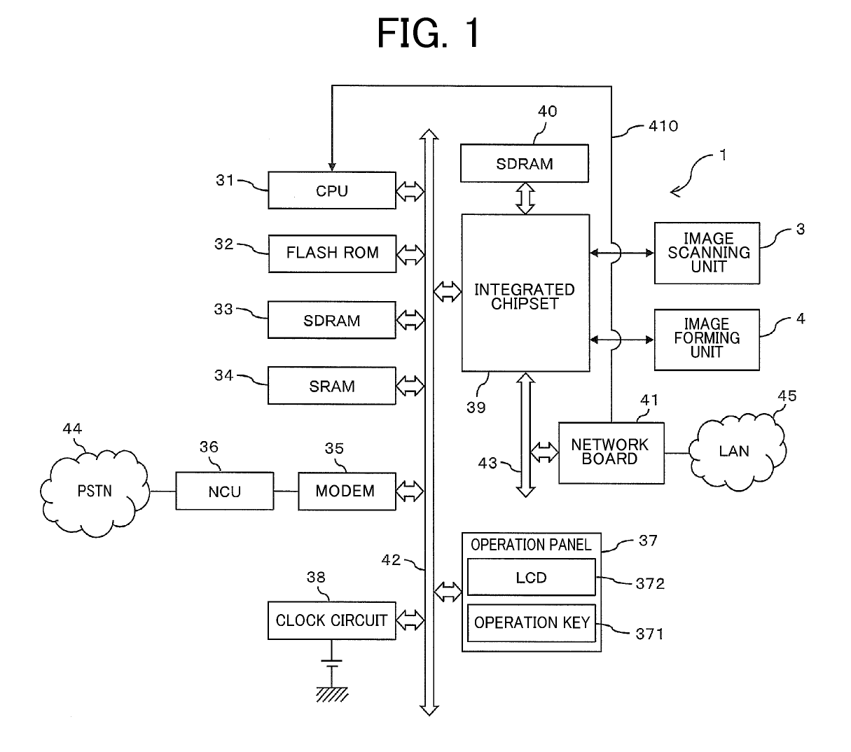

FIG. 1 is a block diagram illustrating an electric structure of a multi-functional peripheral 1, which is an image processing apparatus in accordance with a preferred embodiment of the present invention. The present preferred embodiment will be described with regard to the image processing apparatus is the multi-functional peripheral 1 as an example of the image processing apparatus. However, the image processing apparatus may be installed in other apparatuses, such as a printer, for example. Further, a specific configuration of the multi-functional peripheral 1 is not limited to the configuration described below.

The multi-functional peripheral 1 preferably includes, for example, an image scanning unit 3, an image forming unit 4, a central processing unit (CPU) 31, a flash read-only memory (ROM) 32, a synchronous dynamic random access memory (SDRAM) 33, a static random access memory (SRAM) 34, a modem 35, a network control unit (NCU) 36, an operation panel 37, a clock circuit 38, an integrated chipset 39, a synchronous dynamic random access memory (SDRAM) 40, a network board 41, and the like. The CPU 31, the flash ROM 32, the SDRAM 33, the SRAM 34, the modem 35, the operation panel 37, the clock circuit 38 and the integrated chipset 39 transmit/receive data through a system bus 42.

The image scanning unit 3 and the image forming unit 4 are connected to the integrated chipset 39. The image scanning unit 3 preferably includes, for example, a light receiving section including charge coupled devices (CCDs) and a light emitting section including a plurality of light emitting diodes (LEDs). The light emitting section irradiates light to a document, the light receiving section receives the light reflected from the document, and the CCDs output image data based on an amount of the light that the light receiving section has received. The image forming section 4 preferably includes, for example, a photosensitive drum or the like, and forms an image based on image data of the original scanned with the image scanning section 3 on a recording sheet.

The CPU 31 serves as a controller to control operations of the multi-function peripheral 1. Each of the flash ROM 32, the SDRAM 33, and the SRAM 34 is a memory unit that stores data.

The modem 35 is connected to the public switched telephone networks (PSTN) 44 via the NCU 36. The NCU 36 transmits/receives signals to/from other external communication devices connected to the PSTN 44, which enables the multi-function peripheral 1 to execute speech communication and facsimile communication.

The operation panel 37 is provided with an operation unit for user operation and a display to indicate information for users, and includes, for example, an operation key 371 and a liquid crystal display 37. By operating the operation panel 37, users set operations of the multi-functional peripheral 1 or input instructions. The LCD 372 displays an operational status and setting details of the multi-functional peripheral 1. However, where the LCD 372 is configured with a touch screen, users set the operation of the multi-functional peripheral 1 or input instructions by operating the LCD 372.

The clock circuit 38 is a circuit that measures time and is configured with, for example, a real time clock. The integrated chipset 39 preferably is configured by combining a plurality of integrated circuits. The SDRAM 40 is a storing section where data is input/output through the integrated chipset 39.

The network board 41 sends/receives data between the integrated chipset 39 and a local bus 43. The network board 41 is connected to the LAN 45, and performs network communication with other external communication devices connected to the LAN 45.

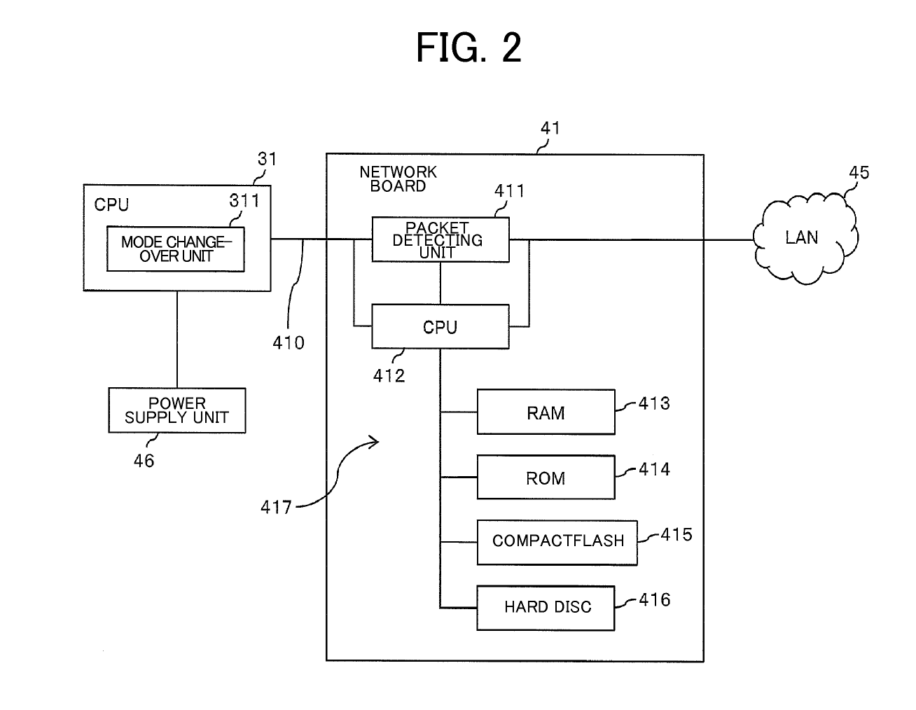

FIG. 2 is a block diagram illustrating a specific structure with respect to network communication via a network board 41. The multi-functional peripheral 1 in accordance with a present preferred embodiment sends/receives a packet via a network (LAN 45). In this preferred embodiment, the network board 41 preferably includes a packet detecting unit 411, a central processing unit (CPU) 412, a RAM 413, a ROM 414, a CompactFlash™ 415, a hard disc drive 416, and the like.

When a packet is transmitted to the multi-functional peripheral 1 via the LAN 45, the packet detecting unit 411 detects the receipt of the packet and outputs an interrupt signal 410 to the CPU 31. The CPU 412, the RAM 413, the ROM 414, CompactFlash™ 415 and the hard disc drive 416 constructs a packet analyzing unit 417 to analyze the packet detected by the packet detecting unit 411. When the packet detecting unit 411 detects receipt of a packet, the CPU 412 analyzes the packet using software stored in the ROM 414 and stores the data obtained through the analysis in the RAM 413, CompactFlash™ 415, or the hard disc drive 416.

If it is determined after the analysis by the packet analyzing unit that the packet is a request to print an image, for example, if a packet of a line printer remote (LPR) protocol is received, the following data to be received may be requests to perform a printing operation with the image forming unit 4. In this case, the image forming unit 41 is configured as an image processing unit that processes an image using image data extracted with the packet analyzing unit 417. However, not limited to the image forming unit 4, the above-mentioned image processing unit may be configured with other elements capable of processing images with the extracted data.

The multi-function peripheral 1 in accordance with a present preferred embodiment is provided with a power supply unit 46 to supply power to each unit of the multi-function peripheral 1. The power supply unit 46 supplies power to at least the packet detecting unit 411, the packet analyzing unit 417 and the image forming unit 4. In a present preferred embodiment, the power supply unit 46 is configured to be capable of switching power supply mode to any one of a stand-by mode, a first power-saving mode, or a second power-saving mode. In the first power-saving mode, power consumption is less than in the stand-by mode, and in the second power-saving mode, power consumption is less than in the first power-saving mode.

The CPU 31 of the multi-function peripheral 1 serves as a mode-changeover unit 311 to switch a supply mode of power supplied by the power supply unit 46 to each one of the above described modes. That is, the mode-changeover unit 311 performs the following mode changeover: from the stand-by mode to the first power-saving mode, from the first power-saving mode to the second power-saving mode, from the second power-saving mode to the first power-saving mode, and from the first power-saving mode to the stand-by mode.

In the first power-saving mode, power supply to the image scanning unit 3, the image forming unit 4 and the operation panel 37 is stopped, for example. In the second power-saving mode, power supply to the modem 35, the integrated chipset 39 and the SDRAM 40 as well as the image scanning unit 3, the image forming unit 4 and the operation panel 37 is stopped, for example. In addition, in the second power-saving mode, power consumed by the CPU 31, the flash ROM 32, the SDRAM 33, the NCU 36 and the network board 41 is reduced as compared to the stand-by mode. The network board 41 in accordance with this preferred embodiment is preferably configured in a way that power is supplied to the packet detecting unit 411 only in the second power-saving mode. The same amount of power as in the stand-by mode is supplied to the SRAM 34 and the clock circuit 38 in either of the first or second power-saving mode.

As described above, in the stand-by mode, the power supply unit 46 supplies power to the packet detecting unit 411, the packet analyzing unit 417 and the image forming unit 4, which allows each unit to operate. In the first power-saving mode, while the packet detecting unit 411 and the packet analyzing unit 417 are maintained to be capable of operating, the image forming unit 4 is incapable of operating as power supply to the image forming unit 4 is stopped or reduced. In the second power-saving mode, while the packet detecting unit 411 is maintained to be capable of operating, the packet analyzing unit 417 and the image forming unit 4 are incapable of operating as power supply to the packet analyzing unit 417 and the image forming unit 4 is stopped or reduced. In this way, the CPU 31 also has a function to maintain each mode of the stand-by mode, the first power-saving mode and the second power-saving mode.

By changing the power supply mode as described above, executable operations vary depending on the particular mode. Specifically, there are more executable operations in the first power-saving mode than in the second power-saving mode, and there are more executable operations in the stand-by mode than in the first power-saving mode. In the second power-saving mode, the following operations preferably are executable, for example: detecting particular packets, receiving facsimile ringing, or receiving interrupt signals from the clock circuit 38. In addition to these operations, in the first power-saving mode, the following operations preferably are also executable: inputting/outputting data via the LAN 45, receiving facsimile transmission and delayed transmission or the like. Furthermore, in the stand-by mode, the image forming unit 4 is capable of performing a printing operation and the like.

Changeover from the stand-by mode to the first power-saving mode can be executed by operating the operation key 371 of the operation panel 37, for example. In this case, the operation key 371 is configured as a changeover directing unit to direct changeover to the first power-saving mode. In a present preferred embodiment, if the image forming unit 4 has not operated for a predetermined period of time in the stand-by mode or an instruction to switch the power supply mode to the first power-saving mode is given in the stand-by mode with the operation key 371, the mode-changeover unit 311 changes the power supply mode from the stand-by mode to the first power-saving mode.

Changeover from the first power-saving mode to the second power-saving mode cannot be executed by operating the operation key 371 of the operation panel 37. The changeover is automatically carried out inside the multi-functional peripheral 1 and users are not able to become aware of the mode changeover. In a present preferred embodiment, the mode-changeover unit 311 is configured to be capable of changing the power supply mode from the first power-saving mode to the second power-saving mode in a case where no packet has been sent/received for a predetermined time of period in the first power-saving mode.

It is preferred that the stand-by mode, the first power-saving mode, and the second power-saving mode can be shifted in this order or in reverse order. However, the number of power-saving modes is not limited to two types like the present preferred embodiment, and therefore three or more of modes may be used.

In a present preferred embodiment, if the packet detecting unit 411 detects a particular packet in the second power-saving mode, the mode-changeover unit 311 changes the power supply mode from the second power-saving mode to the first power-saving mode. Then the packet analyzing unit 417 becomes capable of operating and analyzes the received packet.

While the packet analyzing unit 417 is capable of operating in the first power-saving mode, the packet analyzing unit 417 becomes incapable of operating under a power supply unit in the second power-supplying mode, which further lowers power consumption. In addition, even in the second power-saving mode, when the packet detecting unit 411 detects a particular packet, since the power supply mode is switched to the first power-saving mode, the packet analyzing unit 417 becomes capable of analyzing the received packet, which allows the image processing apparatus to execute network communication. Thus, the multi-functional peripheral 1 prevents unnecessary power consumption, and also performs efficient network communication via a network (LAN 45).

Further, in a present preferred embodiment, only when a packet has not been sent/received for a predetermined period of time, the power supply mode of the multi-functional peripheral 1 is changed from the first power-saving mode to the second power-saving mode. In other words, network communication can be prevented from being disrupted due to mode changeover to the second power-saving mode during packet communication, which eventually enables the multi-functional peripheral 1 to execute efficient network communication.

Furthermore, in a present preferred embodiment, changeover from the stand-by mode to the first power-saving mode is carried out when the image forming unit 4 has not operated and also when an instruction to switch the power supply mode to the first power-saving mode is given through the operation key 371 of the operation panel 37. Thus, by operating the operation key 371 based on the user's intent, wasteful power consumption can be effectively reduced.

Meanwhile, it is preferred that changeover from the first power-saving mode to the second power-saving mode is automatically executed as described above without reference to the user's intent, which prevents a complicated operation or user's confusion due to setting of a plurality of power-saving modes.

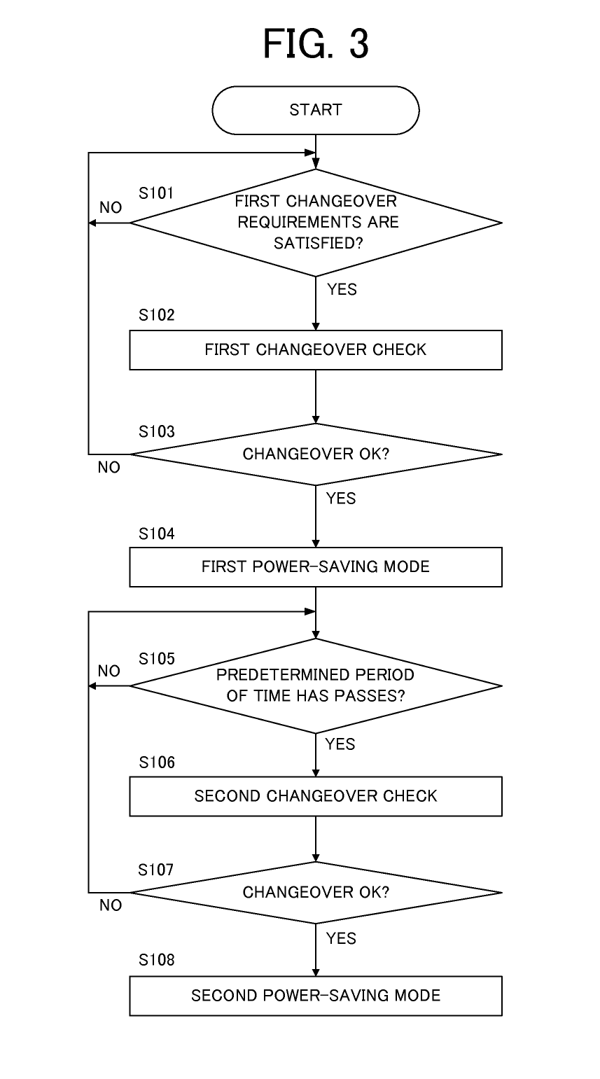

FIG. 3 is a flow chart explaining an example processing by the CPU 31 when the power supply mode of the multi-functional peripheral 1 is sequentially shifted from the stand-by mode through the second power-saving mode.

In the stand-by mode, the CPU 31 monitors operations to determine whether the conditions (first changeover requirements) for changeover from the stand-by mode to the first power-saving mode are satisfied (Step 101). The first changeover requirements are satisfied, for example, if a changeover operation is executed with the operation key 371, or if the multi-functional peripheral 1 has not operated for a predetermined period of time or an instruction for an operation of the multi-functional peripheral 1 has not been given for a predetermined period of time.

Once the first changeover requirements are satisfied (“YES” in S101), it is checked (first changeover check) whether the power supply mode can be switched to the first power-saving mode (Step 102). For example, when a changeover operation is given with the operation key 371 during a printing operation, or when the multi-functional peripheral 1 is in printing operation or another operation, the CPU 31 determines that the power supply mode should not be switched to the first power-saving mode based on the first changeover check (“NO” in Step 103).

Where the CPU 31 determines after the first changeover check that the power supply mode can be switched to the first power-saving mode (“YES” in Step 103), the mode-changeover unit 311 of the CPU 31 changes the power supply mode from the stand-by mode to the first power-saving mode (Step 104). Then, based on a signal input from the clock circuit 38, the CPU 31 monitors the operation to determine whether a given period of time [e.g., ten (10) seconds] passes in the first power-saving mode (Step 105).

If the predetermined period of time has passed in first power-saving mode (“YES” in Step 105), the CPU 31 examines to determine whether (second changeover check) the power supply mode can be switched to the second power-saving mode (Step 106). For example, if a packet has not been sent/received for the above predetermined period of time, the CPU 31 determines that the power supply mode should be switched to the second power-saving mode based on the second changeover check (“YES” in S107), and the mode-changeover unit 311 of the CPU 31 changes the power supply mode from the first power-saving mode to the second power-saving mode (Step 108).

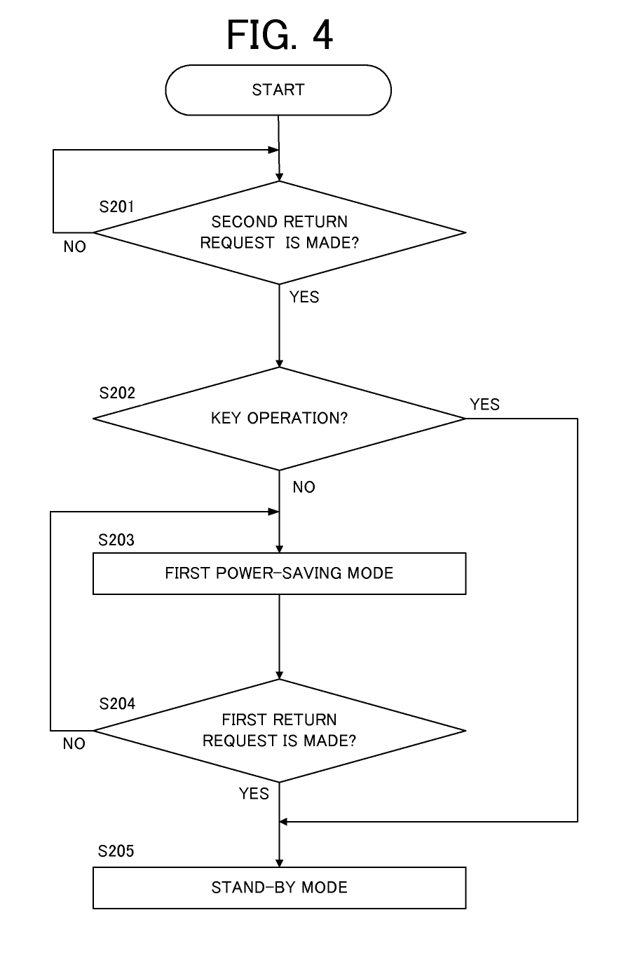

FIG. 4 is a flow chart explaining an example processing by the CPU 31 when the power supply status of the multi-functional peripheral 1 is returned from the second power-saving mode through the stand-by mode.

In the second power-saving mode, the CPU 31 monitors the operations to determine whether a signal requesting the return of the power supply mode from the second power-saving mode to the first power-saving mode (second return request signal) is input (Step 201). For example, when the packet detecting unit 411 detects a particular packet or when a changeover operation is executed with the operation key 371, the second return request signal is input to the CPU 31.

When the second return request signal is input (“YES” in Step 201), the CPU 31 determines whether the second return request signal is input through the changeover operation with the operation key 371 (Step 202). If the second return request signal is input through the changeover operation with the operation key 371 (“YES” in Step 202), the mode-changeover unit 311 of the CPU 31 changes the power supply mode from the second power-saving mode to the stand-by mode (Step 205).

Meanwhile, if the second return request signal is not input through the changeover operation with the operation key 371 (“NO” in Step 202), that is, if the signal has been input since a particular packet is detected, the mode-changeover unit 311 of the CPU 31 changes the power supply mode from the second power-saving mode to the first power-saving mode (Step 203).

In first power-saving mode, the CPU 31 monitors the operation to determine whether a signal requesting the return of the power supply mode from the first power-saving mode to the stand-by mode (first return request signal) is input (Step 204). The first return request signal is input, for example, when an operational instruction is input to the multi-functional peripheral 1. Then, when the first return request signal is input (“YES” in Step 204), the mode-changeover unit 311 of the CPU 31 changes the power supply mode from first the power-saving mode to the stand-by mode (Step 205).

While the present invention has been described with respect to preferred embodiments thereof, it will be apparent to those skilled in the art that the disclosed invention may be modified in numerous ways and may assume many preferred embodiments other than those specifically set out and described above. Accordingly, the appended claims are intended to cover all modifications of the present invention that fall within the true spirit and scope of the present invention.

What is claimed is:

1. An image processing apparatus for sending or receiving a packet via a network comprising:
a packet detecting unit arranged to detect a packet;
a packet analyzing unit arranged to analyze the packet detected by the packet detecting unit;
an image processing unit arranged to process an image using image data extracted from the packet by the packet analyzing unit;
a power supply unit arranged to supply power to the packet detecting unit, the packet analyzing unit and the image processing unit;
a stand-by mode controlling unit arranged to control the packet detecting unit, the packet analyzing unit and the image processing unit to be capable of operating in a stand-by mode;
a first power-saving mode controlling unit arranged to maintain a power supply status so that the packet detecting unit and the packet analyzing unit are both capable of operating while the image processing unit is incapable of operating, in a first power-saving mode;
a second power-saving mode controlling unit arranged to maintain the power supply status so that the packet detecting unit is capable of operating while the packet detecting unit and the image processing unit are incapable of operating, in a second power-saving mode; and
a first mode-changeover unit arranged to change a power supply mode from the second power-saving mode to the first power-saving mode when the packet detecting unit detects a predetermined packet in the second power-saving mode.

2. The image processing apparatus according to claim 1, further comprising:
a determining unit arranged to determine whether image processing needs to be performed based on an analysis conducted by the packet analyzing unit; and
a second mode-changeover unit arranged to change the power supply mode from the first power-saving mode to the stand-by mode based on the determination carried out by the determining unit.

3. The image processing apparatus according to claim 2, further comprising:
a first monitoring unit arranged to monitor operations to determine whether a packet has not been sent or received for a first predetermined period of time in the first power-saving mode; and
a third mode-changeover unit arranged to change the power supply mode from the first power-saving mode to the second power-saving mode based on the monitoring carried out by the first monitoring unit.

4. The image processing apparatus according to claim 3, further comprising:
a second monitoring arranged to monitor operations to determine whether the image processing unit has not operated for a second predetermined period of time in the stand-by mode; and
a fourth mode-changeover unit arranged to change the power supply mode from the stand-by mode to the first power-saving mode based on the monitoring carried out by the second monitoring unit.

5. The image processing apparatus according to claim 3, further comprising:
a changeover directing unit arranged to receive an instruction to switch the power supply mode from the stand-by mode to the first power-saving mode; and
a fifth mode-changeover unit arranged to change the power supply mode from the stand-by mode to the first power-saving mode based on the instruction provided by the changeover directing unit.

6. An image processing apparatus for sending or receiving a packet via a network comprising:
means for detecting receipt of a packet;
means for analyzing the packet detected by the means for detecting;
means for processing an image with image data extracted from the packet;
means for supplying power to detect the packet, to analyze the packet and to process an image;
means for maintaining power supply in a stand-by mode so that each of packet detection, packet analysis and image processing is executable;
means for maintaining power supply in a first power-saving mode so that packet detection and analysis are executable while image processing is not executable;
means for maintaining power supply in a second power-saving mode so that packet detection is executable while packet analysis and image processing are not executable; and
means for changing a power supply mode from the second power-saving mode to the first power-saving mode when a predetermined packet is detected in the second power-saving mode.

7. The image processing apparatus according to claim 6, further comprising:
means for determining whether image processing needs to be performed based on an analysis of the packet; and
means for changing the power supply mode from the first power-saving mode to the stand-by mode based on a determination by the means for determining.

8. The image processing apparatus according to claim 7, further comprising:
means for monitoring operations to determine whether a packet has not been sent/received for the first predetermined period of time in the first power-saving mode; and
means for the changing power supply mode from the first power-saving mode to the second power-saving mode based on monitoring performed by the means for monitoring.

9. The image processing apparatus according to claim 8, further comprising:
second means for monitoring operations of the image processing unit to determine whether the image processing unit has not operated for the second predetermined period of time in the stand-by mode; and
means for changing the power supply mode from the stand-by mode to the first power-saving mode based on the monitoring carried out by the second means for monitoring.

10. The image processing apparatus according to claim 8, further comprising:
means for receiving an instruction to change the power supply mode from the stand-by mode to the first power-saving mode; and
means for changing the power supply mode from the stand-by mode to the first power-saving mode based on the instruction received by the means for receiving.

11. A method for reducing power consumption of an image processing apparatus comprising the steps of:
changing a power supply mode from a stand-by mode to a first power-saving mode in which packet detection and analysis are operable while image processing is inoperable;
changing the power supply mode from the first power-saving mode to a second power-saving mode in which packet detection is operable while packet analysis and image processing are inoperable;
detecting a predetermined packet; and
changing the power supply mode from the second power-saving mode to the first power-saving mode based on receipt of the predetermined packet.

12. The method for reducing power consumption of the image processing apparatus according to claim 11, further comprising the steps of:
analyzing the packet; and
changing the power supply mode from the first power-saving mode to the stand-by mode based on the step of analyzing the packet.

13. The method for reducing power consumption of the image processing apparatus according to claim 12, further comprising the steps of:
monitoring operations to determine whether a packet has been sent or received during a first predetermined period of time in the first power-saving mode; and
changing the power supply mode from the first power-saving mode to the second power-saving mode if a packet has not been sent or received for the first predetermined period of time.

14. The method for reducing power consumption of the image processing apparatus according to claim 13, further comprising the steps of:
monitoring operations to determine whether image processing has not been performed for a second predetermined period of time in the stand-by mode; and
changing the power supply mode from the stand-by mode to the first power mode if image processing has not been performed for the second predetermined period of time.

15. The method for reducing power consumption of the image processing apparatus according to claim 13, further comprising the steps of:
receiving an instruction to change the power supply mode from the stand-by mode to the first power-saving mode; and
changing the power supply mode from the stand-by mode to the first power-saving mode based on the instruction to change the power supply mode.
